(19) United States
(12) Patent Application Publication
(10) Pub. No.: US 2020/0412531 A1
(43) Pub. Date: Dec. 31, 2020

(54) QUANTUM COMMUNICATION CONTROL APPARATUS, QUANTUM COMMUNICATION SYSTEM HAVING QUANTUM COMMUNICATION CONTROL APPARATUS, AND METHOD FOR DESIGNING QUANTUM COMMUNICATION CONTROL APPARATUS

(71) Applicant: ELECTRONICS AND TELECOMMUNICATIONS RESEARCH INSTITUTE, Daejeon (KR)

(72) Inventors: Seok KIM, Daejeon (KR); Eun Ji KIM, Daejeon (KR); Younchang JEONG, Daejeon (KR); Osung KWON, Daejeon (KR); Changho HONG, Daejeon (KR); Nayoung KIM, Daejeon (KR); Se Wan JI, Daejeon (KR); Jingak JANG, Daejeon (KR); Daesung KWON, Daejeon (KR)

(21) Appl. No.: 16/554,994

(22) Filed: Aug. 29, 2019

(30) Foreign Application Priority Data
Jun. 28, 2019 (KR) 10-2019-0077953

(51) Int. Cl. H04L 9/08; G06N 10/00

(52) U.S. Cl. CPC H04L 9/0858; G06N 10/00; H04L 9/0819

(57) ABSTRACT

A quantum communication control apparatus, a quantum communication system having the quantum communication control apparatus, and a method for designing the quantum communication control apparatus. The quantum communication control apparatus includes a first control board configured to include a plurality of connectors and to reconstruct respective functions or signal standards of the plurality of connectors, and at least one second control board configured to include a connector to be connected to any one of the plurality of connectors and to control an optical system implemented according to a protocol or a modulation scheme of quantum communication.

### CROSS REFERENCE TO RELATED APPLICATION

This application claims the benefit of Korean Patent Application No. 10-2019-0077953, filed Jun. 28, 2019, which is hereby incorporated by reference in its entirety into this application.

### BACKGROUND OF THE INVENTION

### 1. Technical Field

The present invention relates generally to a quantum communication control apparatus, a quantum communication system having the quantum communication control apparatus, and a method for designing the quantum communication control apparatus.

### 2. Description of Related Art

Generally, cryptographic communication used in modern society uses a public key cryptography and a symmetric key cryptography together. The recent explosive growth of quantum computing technology has become a great threat factor in public key-based cryptography technology, which guarantees security via the complexity of mathematical algorithms. Further, in a symmetric key cryptography system that is currently used, a secret key having a defined length is repeatedly used several times, and thus the security thereof is also threatened. As a solution to this, quantum cryptography communication technology, as exemplified by quantum key distribution technology, has attractive attention. Quantum key distribution technology may update a new secret key whenever cryptographic communication is needed by solving the problem of secure distribution of secret keys in communication, which was the most serious problem of a symmetric key scheme, thus enabling secure cryptographic communication to be realized. Since the security of cryptographic communication is based on the unique properties of quantum, security may be guaranteed as long as the laws of quantum physics are not broken.

As to quantum cryptography communication, research into and development of optics-based quantum communication based on quantum properties of attenuated laser source have been actively conducted. An optics-based quantum cryptography communication or quantum direct communication system is composed of a physical optics system that includes various types of optical modulators and detectors, and electronic hardware that controls the physical optics.

Generally, there are various protocols for quantum cryptography communication and quantum direct communication, and the same protocol may also be implemented using various types of optical systems according to the modulation scheme. The modulation scheme may be variously selected according to the actual application environment. A physical optics system may be relatively easily reconstructed through the recombination and connection of new optical parts. In contrast, hardware that has been developed once based on defined specifications is limitedly able to adapt to the reconstructed optics system.

### SUMMARY OF THE INVENTION

Accordingly, the present invention has been made keeping in mind the above problems occurring in the prior art, and an object of the present invention is to provide a quantum communication control apparatus, a quantum communication system having the quantum communication control apparatus, and a method for designing the quantum communication control apparatus, which control a physical optics system that can be implemented in various forms according to the protocol and modulation scheme of quantum communication.

The objects of the present invention are not limited to the above-described objects, and other objects, not described here, will be clearly understood by those skilled in the art from the following descriptions.

In accordance with an aspect of the present invention to accomplish the above object, there is provided a quantum communication control apparatus, including a first control board configured to include a plurality of connectors and to reconstruct respective functions or signal standards of the plurality of connectors; and at least one second control board configured to include a connector to be connected to any one of the plurality of connectors and to control an optical system implemented according to a protocol or a modulation scheme of quantum communication.

In an embodiment, the first control board may reconstruct the functions or signal standards through programming of a Field-Programmable Gate Array (FPGA).

In an embodiment, each of the plurality of connectors may be implemented in a form of a slot, and the connector of the at least one second control board may be inserted into a corresponding slot of the first control board.

In an embodiment, the at least one second control board may be configured such that a size of the second control board or a number of connectors of the second control board is varied according to a complexity of a function to be implemented or a number of control signals that is required.

In an embodiment, when the optical system is a 1-way quantum key distribution optical system to which a BB84 protocol is applied, the at least one second control board may include a pulse laser generation board, an intensity modulator control board, a thermoelectric cooler control board, a synchronous laser generation board, and a variable optical attenuator control board so as to transmit photons.

In an embodiment, when the optical system is a 1-way quantum key distribution optical system to which a BB84 protocol is applied, the at least one second control board may include first and second single-photon avalanche diode driving and detection boards, a fiber polarization controller control board, a photodetector driving and detection board, a thermoelectric cooler control board, and a phase modulator control board so as to receive photons.

In an embodiment, when the optical system is a 2-way quantum key distribution optical system to which a BB84 protocol is applied, the at least one second control board may include a phase modulator control board, an intensity modulator control board, a photodetector driving and detection board, and a thermoelectric cooler control board so as to transmit photons.

In an embodiment, when the optical system is a 2-way quantum key distribution optical system to which a BB84 protocol is applied, the at least one second control board may include first and second single-photon avalanche diode driving and detection boards, a phase modulator control board, a pulse laser generation board, and a thermoelectric cooler control board so as to receive photons.

In an embodiment, when the optical system is a Measurement-Device-Independent (MDI) quantum key distribution system, the at least one second control board may include a pulse laser generation board, an intensity modulator control board, a phase modulator control board, a thermoelectric cooler control board, a synchronous laser generation board, and a variable optical attenuator control board so as to transmit photons.

In an embodiment, when the optical system is a Measurement-Device-Independent (MDI) quantum key distribution system, the at least one second control board may include first to fourth single-photon avalanche diode driving and detection boards, first and second photodetector driving and detection boards, and first and second fiber polarization controller control boards so as to measure Bell states.

In embodiment, when the optical system is a quantum key distribution optical system to which a B92 protocol is applied, the at least one second control board may include first and second pulse laser generation boards, a synchronous laser generation board, and first and second variable optical attenuator control boards so as to transmit photons.

In an embodiment, when the optical system is a quantum key distribution optical system to which a B92 protocol is applied, the at least one second control board may include first and second single photon avalanche diode driving and detection boards, a fiber polarization controller control board, and a photodetector driving and detection board so as to receive photons.

The quantum communication control apparatus may be operated as a quantum communication test device for testing components of a quantum communication system.

In accordance with another aspect of the present invention to accomplish the above object, there is provided a quantum communication system, including a sender for transmitting photons; and a receiver for receiving the photons through a quantum channel, wherein each of the sender and the receiver includes an optical system for quantum communication, wherein each of the sender and the receiver includes a quantum communication control apparatus, and wherein the quantum communication control apparatus may include a first control board configured to include plurality of connectors and to reconstruct respective functions or signal standards of the plurality of connectors; and a plurality of second control boards, each configured to include a connector to be connected to any one of the plurality of connectors and to control the optical system according to a protocol or a modulation scheme of quantum communication.

In an embodiment, the optical system may include a 1-way or 2-way quantum key distribution optical system to which a BB84 protocol is applied.

In an embodiment, the optical system may include a Measurement-Device-Independent (MDI) quantum key distribution optical system.

In an embodiment, the optical system may include a quantum key distribution optical system to which a B92 protocol is applied.

In an embodiment, the quantum communication system may be configured to perform quantum cryptography communication via optical modulation, and at least one of the plurality of second control boards may be replaced according to an optical modulation scheme.

In an embodiment, the quantum communication system may further include a Bell state measurement unit for receiving the photons output from a plurality of senders and measuring relationships between quantum states of the received photons, wherein the Bell state measurement unit may include a main board configured to include connectors and to reconstruct respective functions or signal standards of the connectors; and individual boards, each connected to any one of the connectors and configured to control the optical system according to the protocol or the modulation scheme.

In accordance with a further aspect of the present invention to accomplish the above object, there is provided a method for designing a quantum communication control apparatus, including preparing a main board having plurality of connectors; selecting individual boards according to a protocol or a modulation scheme of quantum communication; and connecting each of the selected individual boards to a corresponding connector, among the plurality of connectors.

In an embodiment, each of the plurality of connectors may be implemented in a form of a slot, and connecting each of the selected individual boards to the corresponding connector may include inserting the selected individual boards into corresponding slots in the main board.

In an embodiment, preparing the main board may include reconstructing respective functions or signal standards of the plurality of connectors through programming of a Field-Programmable Gate Array (FPGA).

### BRIEF DESCRIPTION OF THE DRAWINGS

The accompanying drawings are provided to help the understanding of the present embodiments, and the embodiments are provided together with the detailed descriptions thereof. However, the technical features of the present embodiments are not limited to specific drawings, and the features disclosed in respective drawings may be combined to configure new embodiments.

FIG. 1 is a diagram illustrating a quantum key distribution system for typical quantum cryptography communication;

FIG. 2 is a diagram exemplarily illustrating a quantum communication control apparatus according to an embodiment of the present invention;

FIG. 3 is a diagram exemplarily illustrating a quantum communication system having a 1-way quantum key distribution optical system to which a BB84 protocol is applied according to an embodiment of the present invention;

FIG. 4 is a diagram exemplarily illustrating a quantum communication transmission control apparatus for controlling the sender of the quantum communication system of FIG. 3;

FIG. 5 is a diagram exemplarily illustrating a quantum communication reception control apparatus for controlling the receiver of the quantum communication system of FIG. 3;

FIG. 6 is a diagram exemplarily illustrating a quantum communication system having a 2-way quantum key distribution optical system to which a BB84 protocol is applied according to an embodiment of the present invention;

FIG. 7 is a diagram exemplarily illustrating a quantum communication transmission control apparatus for controlling the sender of the quantum communication system of FIG. 6;

FIG. 8 is a diagram exemplarily illustrating a quantum communication reception control apparatus for controlling the receiver of the quantum communication system of FIG. 6;

FIG. 9 is a diagram exemplarily illustrating a quantum communication system having an MDI-type quantum key distribution optical system according to an embodiment of the present invention;

FIG. 10 is a diagram exemplarily illustrating a quantum communication transmission control apparatus for controlling the senders of FIG. 9;

FIG. 11 is a diagram exemplarily illustrating a quantum communication Bell state measurement control apparatus for controlling the Bell state measurement unit of FIG. 9;

FIG. 12 is a diagram exemplarily illustrating a quantum communication system having a quantum key distribution optical system to which a B92 protocol is applied according to an embodiment of the present invention;

FIG. 13 is a diagram exemplarily illustrating a quantum communication transmission control apparatus for controlling the sender of FIG. 12;

FIG. 14 is a diagram exemplarily illustrating a quantum communication reception control apparatus corresponding to the receiver of FIG. 12; and

FIG. 15 is a flowchart exemplarily illustrating a method for designing a quantum communication control apparatus according to an embodiment of the present invention.

### DESCRIPTION OF THE PREFERRED EMBODIMENTS

Embodiments of the present invention are described with reference to the accompanying drawings in order to describe the present invention in detail so that those having ordinary knowledge in the technical field to which the present invention pertains can easily practice the present invention.

Reference will now be made in detail to various embodiments of the present invention, specific examples of which are illustrated in the accompanying drawings and described below, since the embodiments of the present invention can be variously modified in many different forms. However, this is not intended to limit the present invention to particular modes of practice, and it is to be appreciated that all changes, equivalents, and substitutes that do not depart from the spirit and technical scope of the present invention are encompassed in the present invention. It will be understood that, although the terms “first” and “second” may be used herein to describe various elements, these elements should not be limited by these terms. These terms are only used to distinguish one element from another element. For instance, a first element discussed below could be termed a second element without departing from the teachings of the present invention. Similarly, the second element could also be termed the first element. It will be understood that when an element is referred to as being “coupled” or “connected” to another element, it can be directly coupled or connected to the other element, or intervening elements may be present therebetween. In contrast, it should be understood that when an element is referred to as being “directly coupled” or “directly connected” to another element, there are no intervening elements present.

The terminology used herein is for the purpose of describing particular embodiments only and is not intended to be limiting. In the present invention, the singular forms are intended to include the plural forms as well, unless the context clearly indicates otherwise. It should be further understood that the terms “comprise”, “include”, and “have”, when used in this specification, specify the presence of stated features, integers, steps, operations, elements, components, and/or combinations thereof, but do not preclude the presence or addition of one or more other features, integers, steps, operations, elements, components, and/or combinations thereof. Unless differently defined, all terms used here including technical or scientific terms have the same meanings as terms generally understood by those skilled in the art to which the present invention pertains. Terms identical to those defined in generally used dictionaries should be interpreted as having meanings identical to contextual meanings of the related art, and are not to be interpreted as having ideal or excessively formal meanings unless they are definitely defined in the present specification.

Generally, quantum communication is a communication scheme that follows a new paradigm based on quantum mechanics. Current quantum communication fields are classified into a quantum cryptography communication field, in which quantum key distribution and cryptographic processing are associated with each other, and a quantum direct communication field, in which direct communication is performed using quanta without using a previously shared key.

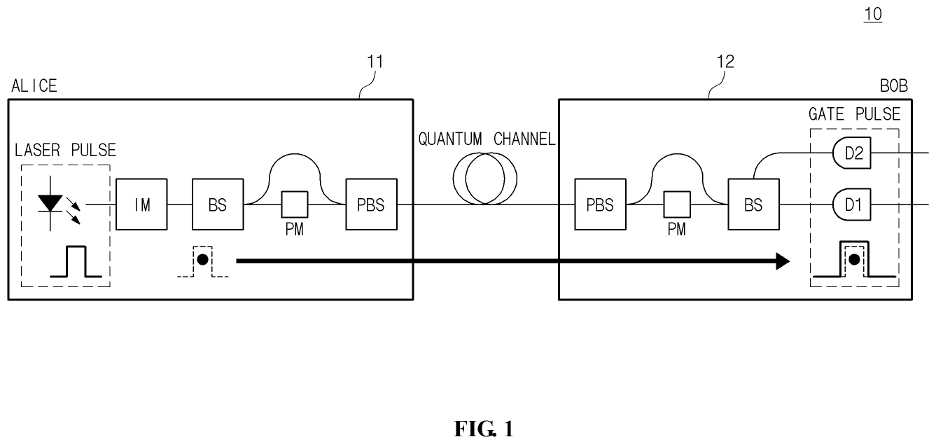

FIG. 1 is a diagram illustrating a quantum key distribution system for typical quantum cryptography communication. Referring to FIG. 1, a quantum key distribution system 10 may include a sender (ALICE) 11 and a receiver (BOB) 12.

The sender 11 may include an Intensity Modulator (IM), a Beam Splitter (BS), a Phase Modulator (PM), and a Polarizing Beam Splitter (PBS). The receiver 12 may include a Polarizing Beam Splitter (PBS), a Phase Modulator (PM), a Beam Splitter (B S), and single-photon detectors D1 and D2.

In quantum cryptography communication, research into and development of optics-based quantum communication based on the quantum characteristics of a pseudo single-photon source that is generated through the attenuated laser source have been actively conducted. An optics-based quantum cryptography communication or quantum direct communication system is composed of a physical optics system which includes various types of optical modulators and detectors and electronic hardware which controls the physical optics system.

Generally, there are various protocols for quantum cryptography communication and quantum direct communication, and the same protocol may also be implemented using various types of optical systems according to the modulation scheme. The modulation scheme may be variously selected according to the actual application environment. A physical optics system may be relatively easily reconstructed through the combination and connection of new optical parts. In contrast, hardware that has been developed once according to the defined specification is limitedly able to adapt to the reconstruction of a physical optics system.

A quantum communication control apparatus, a quantum communication system having the quantum communication control apparatus, and a method for designing the quantum communication control apparatus according to embodiments of the present invention may reconstruct a control apparatus in accordance with a physical optics system that is manufactured in various forms according to the protocol/modulation scheme.

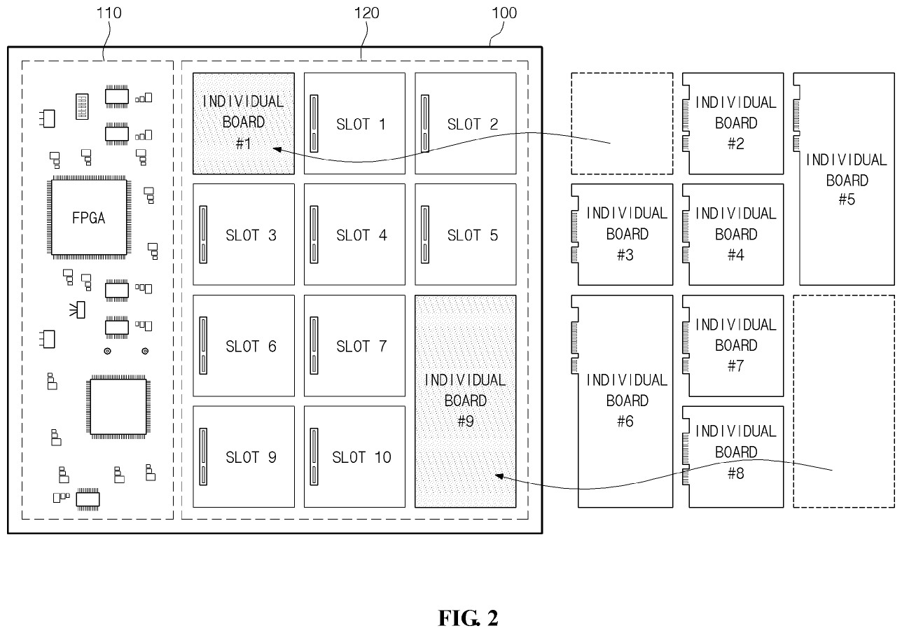

FIG. 2 is a diagram exemplarily illustrating a quantum communication control apparatus 100 according to an embodiment of the present invention. Referring to FIG. 2, the quantum communication control apparatus 100 may include a first control board (hereinafter also referred to as a ‘main board’) 110 and a set of second control boards (hereinafter also referred to as a ‘individual board’).

The first control board 110 may include plurality of connectors that are compatible with each other. Individual boards for respective multiple functions may be arbitrarily coupled to main board through the plurality of connectors (e.g., SLOT 0 to SLOT 11). Although the number of connectors is 12 in FIG. 2, it should be understood that the number of connectors in the present invention is not limited thereto.

In an embodiment, the first control board 110 may include a Field-Programmable Gate Array (FPGA). In an embodiment, the first control board 110 may reconstruct the functions or signal standards of respective connectors through FPGA programming. Meanwhile, it should be understood that programming of the main board according to the present invention is not limited to such FPGA programming.

A set of second control boards 120 may include at least one individual board for controlling optical elements for respective functions. In an embodiment, the individual board may be coupled to the first control board 110 in the form of a slot. However, it should not be understood that the individual board of the present invention is coupled only in the form of a slot. That is, in accordance with physical optics systems that may be manufactured in various forms, a quantum communication control apparatus may be implemented by the reconstruction of individual boards and the FPGA.

Each individual board may include a connector that is compatible with the connector of the first control board 110. In an embodiment, the individual board may take charge of control and output signal processing for various optical elements and modules used in quantum communication. For example, the individual board may be one of an optical modulator control board, a polarization controller control board, a Single-Photon Avalanche Diode (SPAD) driving and detection board, a laser diode driving control board, a PIN photodetector (PINPD) detection board, a coincidence measurement board, an optical attenuator control board, and a temperature stabilization Thermoelectric Cooler (TEC) control board.

In an embodiment, the individual board may be designed in a form having a size that is a plurality of that of a basic individual board and having a number of connectors corresponding to a plurality of the number of connectors of the basic individual board according to the complexity of the function to be implemented and the number of control signals (see individual boards #5, #6, and #9) that is required.

The quantum communication control apparatus 100 according to an embodiment of the present invention may be implemented merely by additionally developing some individual boards when a quantum communication protocol to which a new optical element that was not previously used is applied is proposed. Also, the quantum communication control apparatus 100 of the present invention may be applied to quantum communication tests. For example, the quantum communication control apparatus 100 may be operated as a quantum communication test device for testing the components of a quantum communication system.

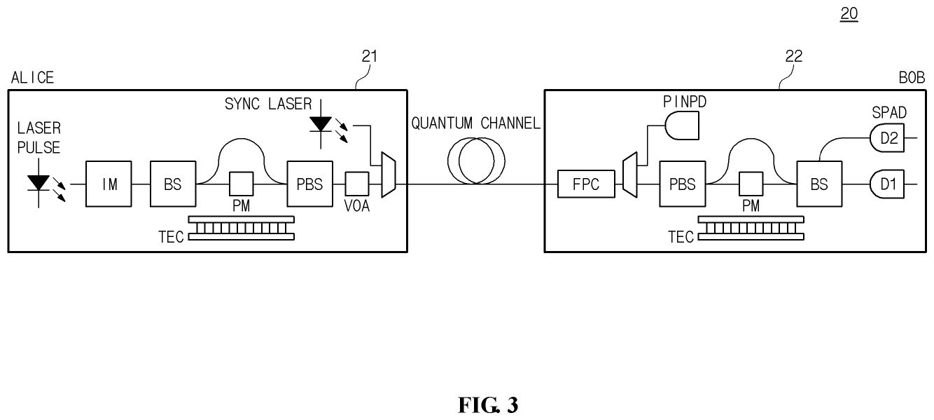

FIG. 3 is a diagram exemplarily illustrating a quantum communication system 20 having a 1-way quantum key distribution optical system to which a BB84 protocol is applied according to an embodiment of the present invention. Referring to FIG. 3, the quantum communication system 20 may include a sender (ALICE) 21 and a receiver (BOB) 22.

The sender 21 may include an Intensity Modulator (IM), a Beam Splitter (BS), a Phase Modulator (PM), a Thermoelectric Cooler (TEC), a Polarizing Beam Splitter (PBS), and a Variable Optical Attenuator (VOA).

The receiver 22 may include a Fiber Polarization Controller (FPC), a PIN photodetector (PINPD), a Polarizing Beam Splitter (PBS), a Phase Modulator (PM), a TEC, a Beam Splitter (BS), and Single-Photon Avalanche Diodes (SPAD) D1 and D2.

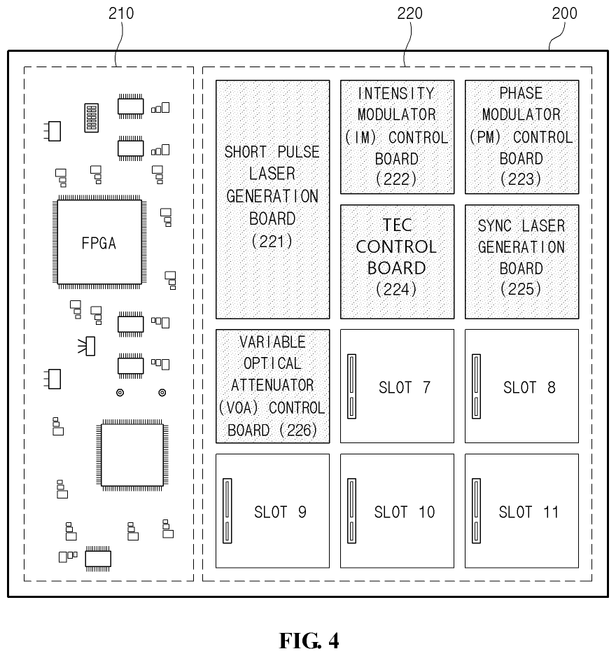

FIG. 4 is a diagram exemplarily illustrating a quantum communication transmission control apparatus 200 corresponding to the sender 21 of the quantum communication system 20 of FIG. 3. Referring to FIG. 4, the quantum communication transmission control apparatus 200 may include a first control board 210 and a set of second control boards 220.

The first control board 210 may be implemented in the same structure as the first control board 110 illustrated in FIG. 2.

A set of second control boards 220 may include a laser generation board 221, an IM control board 222, a PM control board 223, a TEC control board 224, a synchronous (SYNC) laser generation board 225, and a VOA control board 226.

Generally, the quantum communication system 20 may be configured using various optical elements, such as an Intensity Modulator (IM), a Phase Modulator (PM), and a Variable Optical Attenuator (VOA), according to the modulation scheme and implementation scheme. These optical elements may be controlled in response to electrical signals meeting standard requirements of respective optical elements.

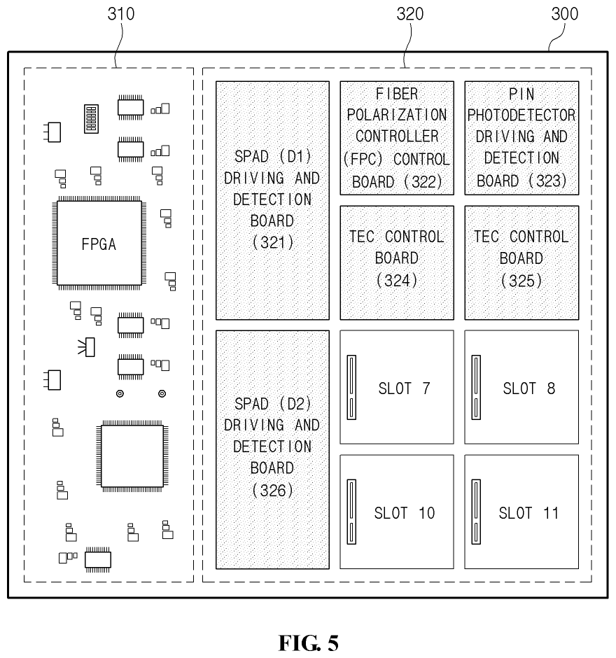

FIG. 5 is a diagram exemplarily illustrating a quantum communication reception control apparatus 300 corresponding to the receiver 22 of the quantum communication system 20 of FIG. 3. Referring to FIG. 5, the quantum communication reception control apparatus 300 may include a first control board 310 and a set of second control boards 320.

The first control board 310 may be implemented in the same structure as the first control board 110 illustrated in FIG. 2.

A set of second control boards 320 may include a SPAD (D1) driving and detection board 321, an FPC control board 322, a PINPD driving and detection board 323, a TEC control board 324, a Phase Modulator (PM) control board 325, and a SPAD (D2) driving and detection board 326.

The quantum communication control apparatus 100 illustrated in FIG. 2 may be implemented to correspond to the optical systems of both the transmission control apparatus (ALICE) 200 and the reception control apparatus (BOB) 300 through a product developed according to the present invention, composed of a main board and individual boards for respective optical elements.

Meanwhile, the quantum communication system 20 according to an embodiment of the present invention may perform quantum cryptography communication through phase modulation. Switching from such a phase modulation scheme to a polarization modulation scheme or the like may be performed merely by replacing the corresponding individual board.

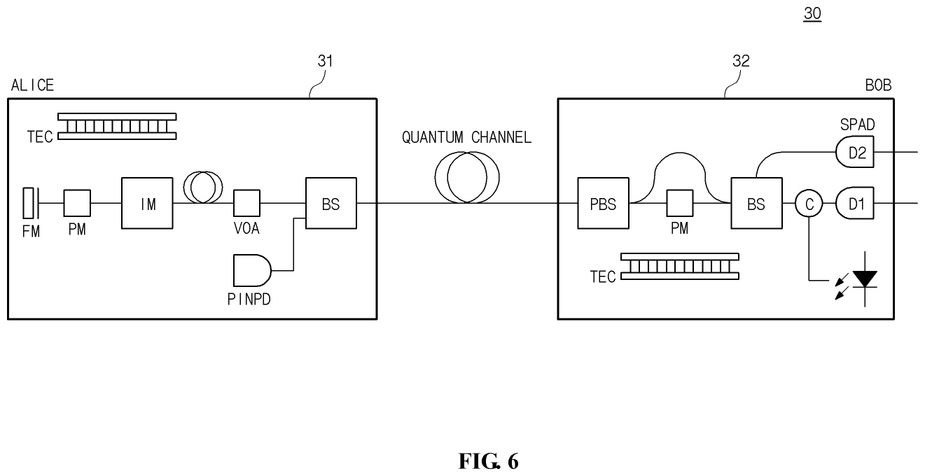

FIG. 6 is a diagram exemplarily illustrating a quantum communication system 30 having a 2-way quantum key distribution optical system to which a BB84 protocol is applied according to an embodiment of the present invention. Referring to FIG. 6, the quantum communication system 30 may include a sender (ALICE) 31 and a receiver (BOB) 32.

The sender 31 may include a Faraday Mirror (FM), a Phase Modulator (PM), an Intensity Modulator (IM), a Variable Optical Attenuator (VOA), a PIN photodetector (PINPD), and a Beam splitter (BS).

The receiver 32 may include a Polarizing Beam Splitter (PBS), a Phase Modulator (PM), a Thermoelectric Cooler (TEC), a Beam Splitter (BS), a Coupler (C), and photodetectors D1 and D2.

Since a laser signal generated by the receiver (BOB) 32 reciprocates along the quantum channel, it may be detected by the receiver (BOB) 32. In an embodiment, during a procedure for reciprocating along the quantum channel, environmental variation (e.g. variation in polarization) may be cancelled.

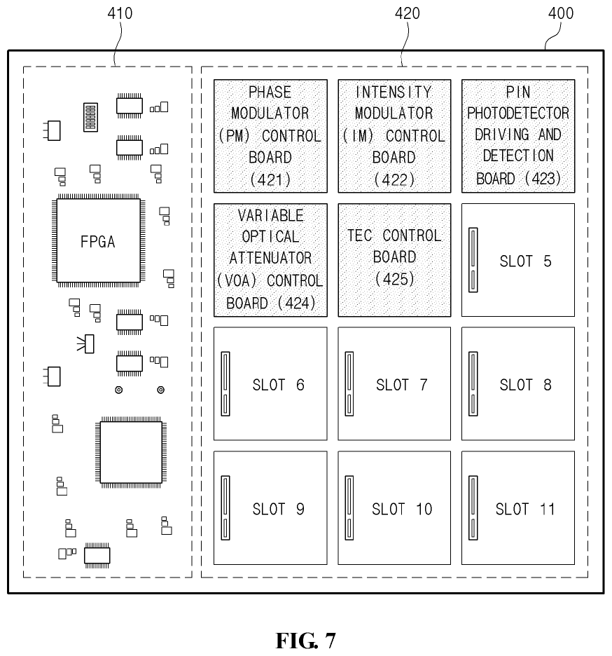

FIG. 7 is a diagram exemplarily illustrating a quantum communication transmission control apparatus 400 for controlling the sender 31 of the quantum communication system 30 of FIG. 6. Referring to FIG. 7, the quantum communication transmission control apparatus 400 may include a first control board 410 and a set of second control boards 420.

The first control board 410 may be implemented in the same structure as the first control board 110 illustrated in FIG. 2.

A set of second control boards 420 may include a PM control board 421, an IM control board 422, a PINPD driving and detection board 423, a VOA control board 424, and a TEC control board 425.

Since variation in polarization is cancelled during a procedure for reciprocating along a quantum channel, an FPC control board used in an existing 1-way scheme may be removed, and the pulse laser generation board of the sender 31 may be shifted to the receiver (BOB) 32.

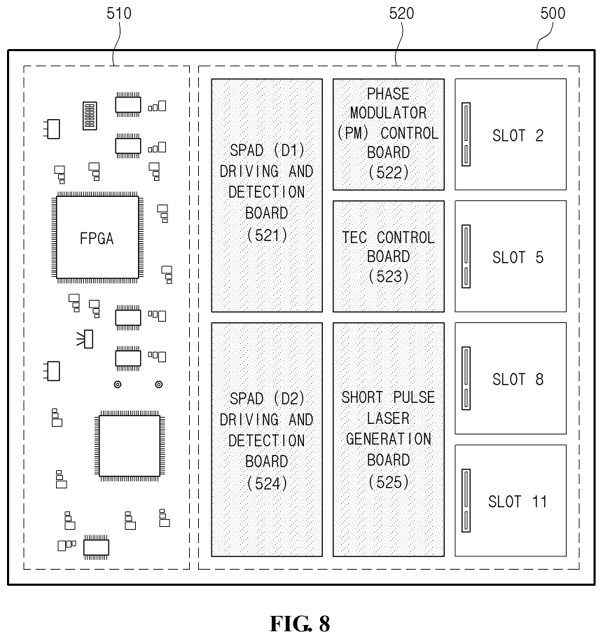

FIG. 8 is a diagram exemplarily illustrating a quantum communication reception control apparatus 500 corresponding to the receiver 32 of the quantum communication system 30 of FIG. 6. Referring to FIG. 8, the quantum communication reception control apparatus 500 may include a first control board 510 and a set of second control boards 520.

The first control board 510 may be implemented in the same structure as the first control board 110 illustrated in FIG. 2.

A set of second control boards 520 may include a SPAD (D1) driving and detection board 521, a PM control board 522, a TEC control board 523, a SPAD (D2) driving and detection board 524, and a pulse laser generation board 525.

Meanwhile, the present invention may also be applied to a Measurement-Device-Independent (MDI) quantum key distribution optical system, which has relatively increased complexity, but is capable of increasing a quantum communication distance.

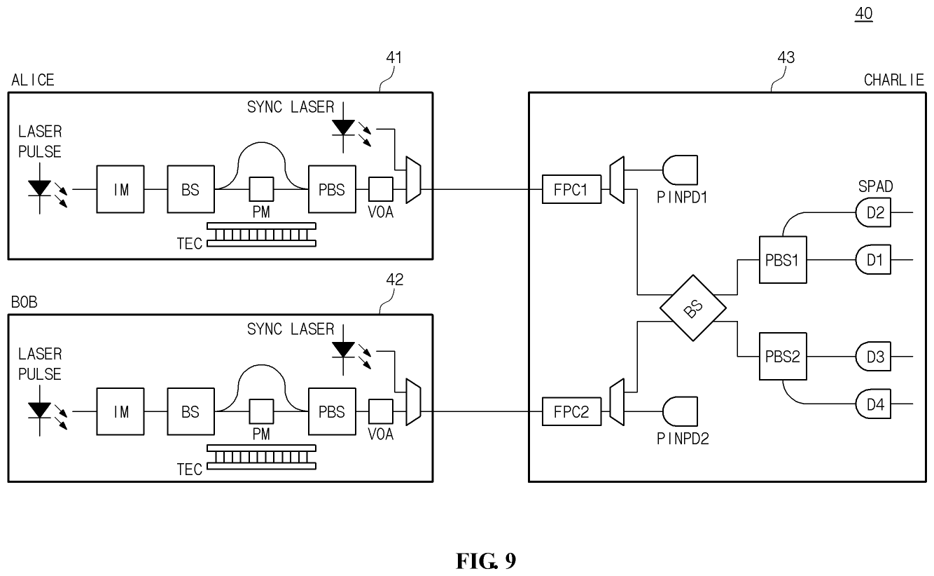

FIG. 9 is a diagram exemplarily illustrating a quantum communication system 40 having an MDI quantum key distribution optical system according to an embodiment of the present invention. Referring to FIG. 9, the quantum communication system 40 may include two senders (ALICE) 41 and (Bob) 42 and a Bell state measurement unit (CHARLIE) 43.

Each of the senders 41 and 42 may include an Intensity Modulator (IM), a Beam Splitter (BS), a Phase modulator PM, a Thermoelectric Cooler (TEC), a Polarizing Beam Splitter (PBS), and a Variable Optical Attenuator (VOA). The Bell state measurement unit 43 may include a first Fiber Polarization Controller (FPC1), a second FPC (FPC2), a first PIN photodetector (PINPD1), a second PINPD (PINPD2), a Beam Splitter (BS), a first Polarizing Beam Splitter (PBS1), a second PBS (PBS2), and first, second, third and fourth Single-Photon Avalanche Diodes (SPAD) D1, D2, D3, and D4.

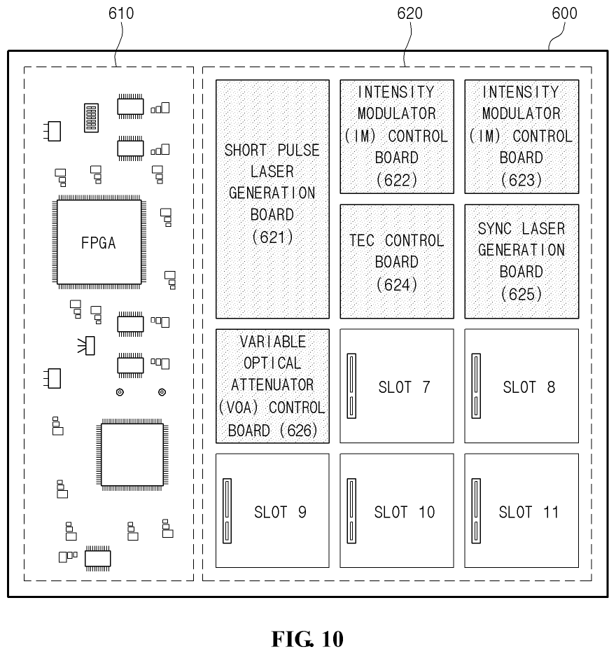

FIG. 10 is a diagram exemplarily illustrating a quantum communication transmission control apparatus 600 for controlling the senders 41 and 42 of FIG. 9. Referring to FIG. 10, the quantum communication transmission control apparatus 600 may include a first control board 610 and a set of second control boards 620.

The first control board 610 may be implemented in the same structure as the first control board 110 illustrated in FIG. 2.

A set of second control boards 620 may include a laser generation board 621, an IM control board 622, a PM control board 623, a TEC control board 624, a synchronous (SYNC) laser generation board 625, and a VOA control board 626.

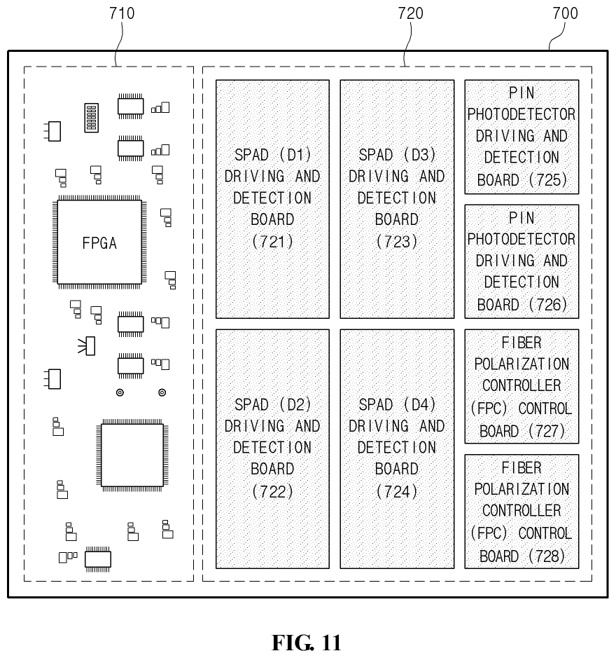

FIG. 11 is a diagram exemplarily illustrating a quantum communication Bell state measurement control apparatus 700 for controlling the Bell state measurement unit 43 of FIG. 9. Referring to FIG. 11, the quantum communication Bell state measurement control apparatus 700 may include a first control board 710 and a set of second control boards 720.

The first control board 710 may be implemented in the same structure as the first control board 110 illustrated in FIG. 2.

A set of second control boards 720 may include first to fourth SPAD (D1) driving and detection boards 721, 722, 723, and 724, first and second PINPD driving and detection boards 725 and 726, and first and second FPC control boards 727 and 728.

The senders 41 and 42 and the Bell state measurement unit 43 may be respectively configured by coupling a different set of individual boards to the same main boards, according to the functions thereof. By means of this configuration, quantum cryptography communication may be performed by controlling the optical systems of the senders 41 and 42 and the Bell state measurement unit 43.

Meanwhile, the present invention may also be applied to a quantum key distribution optical system to which a B92 protocol is applied.

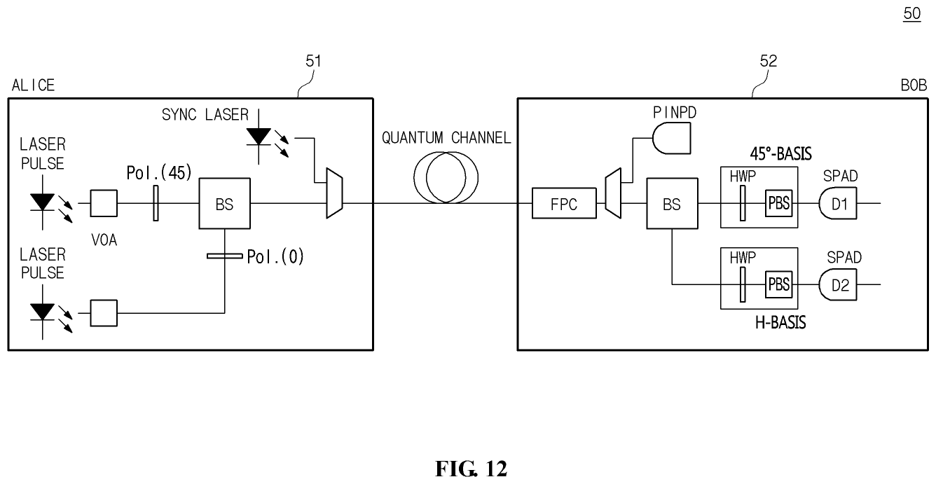

FIG. 12 is a diagram exemplarily illustrating a quantum communication system 50 having a quantum key distribution optical system to which a B92 protocol is applied according to an embodiment of the present invention. The quantum communication system 50 may include a sender 51 and a receiver 52.

The sender 51 may include a VOA, a 45° or 0° polarizer (polarizing plate), and a Beam Splitter (BS). The receiver 52 may include a Fiber Polarization Controller (FPC), a PIN photodetector (PINPD), a BS, a Half-Wave Plate (HWP), a PBS, and Single-Photon Avalanche Diodes (SPAD) D1 and D2.

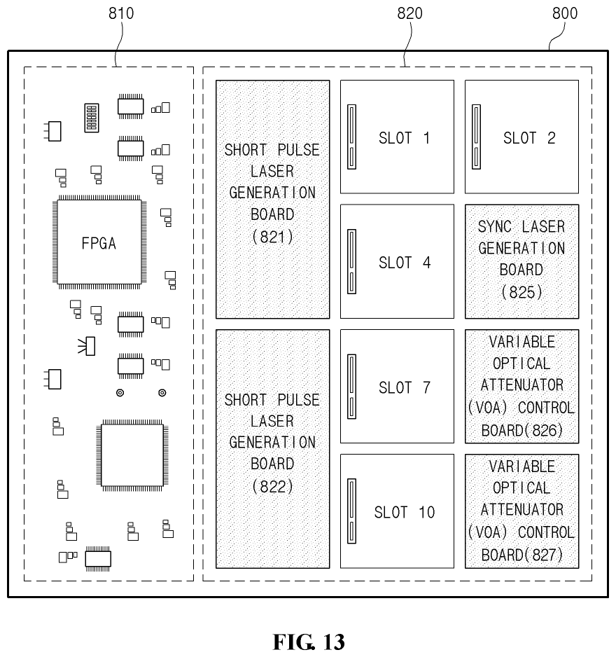

FIG. 13 is a diagram exemplarily illustrating a quantum communication transmission control apparatus 800 for controlling the sender 51 of the quantum communication system 50 of FIG. 12. Referring to FIG. 13, the quantum communication transmission control apparatus 800 may include a first control board 810 and a set of second control boards 820.

The first control board 810 may be implemented to have the same structure as the first control board 110 illustrated in FIG. 2.

A set of second control boards 820 may include first and second laser generation boards 821 and 822, a synchronous laser generation board 825, and first and second VOA control boards 826 and 827.

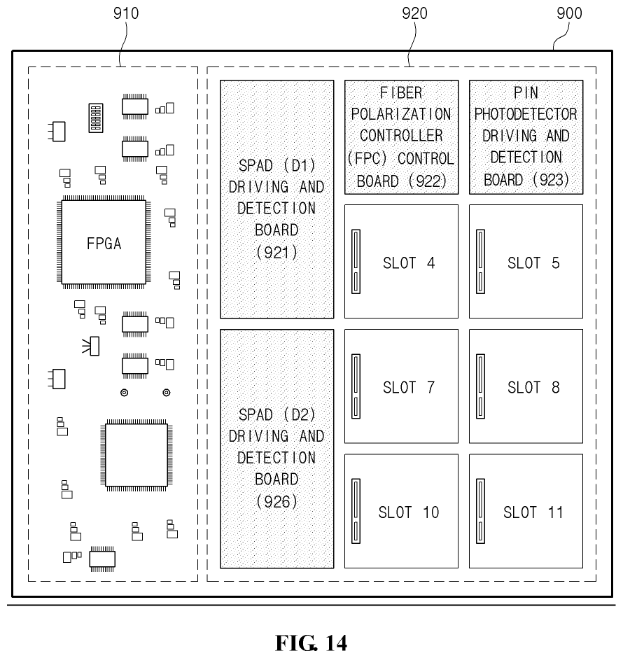

FIG. 14 is a diagram exemplarily illustrating a quantum communication reception control apparatus 900 for controlling the receiver 52 of the quantum communication system 50 of FIG. 12. Referring to FIG. 14, the quantum communication reception control apparatus 900 may include a first control board 910 and a set of second control boards 920.

The first control board 910 may be implemented to have the same structure as the first control board 110 illustrated in FIG. 2.

A set of second control boards 920 may include a SPAD (D1) driving and detection board 921, an FPC control board 922, a PINPD driving and detection board 923, and a SPAD (D2) driving and detection board 926.

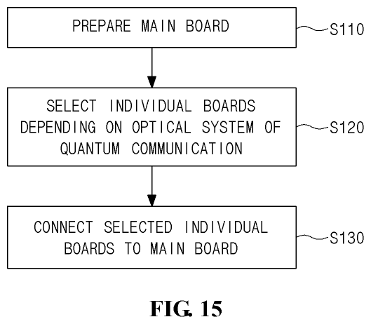

FIG. 15 is a flowchart exemplarily illustrating a method for designing a quantum communication control apparatus according to an embodiment of the present invention. Referring to FIGS. 1 to 15, the method for designing the quantum communication control apparatus may be performed as follows.

A main board having a plurality of connectors may be prepared at step S110. Individual boards for controlling an optical system may be selected according to the protocol/modulation scheme of quantum communication at step S120. The selected individual boards may be connected to each other through the connectors of a main board at step S130.

In an embodiment, each of the plurality of connectors may be implemented in the form of a slot, and the selected individual boards may be inserted into the corresponding slots in the main board. In an embodiment, when the main board is prepared, respective functions or signal standards of the plurality of connectors may be reconstructed through the programming of a Field-Programmable Gate Array (FPGA).

There may be various protocols for quantum cryptography communication and quantum direct communication, and the same protocol may also be implemented using various types of optical systems according to the modulation scheme. Here, the modulation scheme may be variously selected according to the actual application environment. A physical optics system may be relatively easily reconstructed through the recombination and connection of new optical parts.

Since conventional quantum communication control hardware is developed for a single defined optical system, it is limitedly able to adapt to the reconstruction of a physical optics system. In contrast, the quantum communication control apparatus and the method for designing the apparatus according to embodiments of the present invention may flexibly respond to the reconstruction of the physical optics system, and may support various quantum communication protocols or optical modulation methods using hardware that has been developed once.

The quantum communication control apparatus, the quantum communication system having the quantum communication control apparatus, and the method for designing the quantum communication control apparatus according to embodiments of the present invention may allow individual boards to be connected to a main board to be selected, thus enabling a physical optics system to be reconstructed to correspond to various types of optical systems according to various protocols and modulation schemes for quantum cryptography communication and quantum direct communication.

The quantum communication control apparatus, the quantum communication system having the quantum communication control apparatus, and the method for designing the quantum communication control apparatus according to embodiments of the present invention may flexibility adapt to the reconstruction of a physical optics system, and may support various quantum communication protocols or optical modulation methods using hardware that has been developed once.

Meanwhile, the descriptions of the present invention are only detailed embodiments for practicing the present invention. The present invention may include not only detailed and actually available means but also the technical spirit indicating abstract and conceptual ideas that can be utilized as technology in the future.

What is claimed is:

1. A quantum communication control apparatus comprising:
a first control board configured to include a plurality of connectors and to reconstruct respective functions or signal standards of the plurality of connectors; and
at least one second control board configured to include a connector to be connected to any one of the plurality of connectors and to control an optical system implemented according to a protocol or a modulation scheme of quantum communication.

2. The quantum communication control apparatus of claim 1, wherein the first control board reconstructs the functions or signal standards through programming of a Field-Programmable Gate Array (FPGA).

3. The quantum communication control apparatus of claim 1, wherein:
each of the plurality of connectors is implemented in a form of a slot, and
the connector of the at least one second control board is inserted into a corresponding slot of the first control board.

4. The quantum communication control apparatus of claim 1, wherein the at least one second control board varies a size of the second control board or a number of connectors of the second control board according to a complexity of a function to be implemented or a number of control signals that is required.

5. The quantum communication control apparatus of claim 1, wherein, when the optical system is a 1-way quantum distribution optical system to which a BB84 protocol is applied, the at least one second control board comprises a pulse laser generation board, an intensity modulator control board, a thermoelectric cooler control board, a synchronous laser generation board, and a variable optical attenuator control board so as to transmit photons.

6. The quantum communication control apparatus of claim 1, wherein, when the optical system is a 1-way quantum key distribution optical system to which a BB84 protocol is applied, the at least one second control board comprises first and second single-photon avalanche diode driving and detection boards, a fiber polarization controller control board, a photodetector driving and detection board, a thermoelectric cooler control board, and a phase modulator control board so as to receive photons.

7. The quantum communication control apparatus of claim 1, wherein, when the optical system is a 2-way quantum key distribution optical system to which a BB84 protocol is applied, the at least one second control board comprises a phase modulator control board, an intensity modulator control board, a photodetector driving and detection board, and a thermoelectric cooler control board so as to transmit photons.

8. The quantum communication control apparatus of claim 1, wherein, when the optical system is a 2-way quantum key distribution optical system to which a BB84 protocol is applied, the at least one second control board comprises first and second single-photon avalanche diode driving and detection boards, a phase modulator control board, a pulse laser generation board, and a thermoelectric cooler control board so as to receive photons.

9. The quantum communication control apparatus of claim 1, wherein, when the optical system is a Measurement-Device-Independent (MDI) quantum key distribution system, the at least one second control board comprises a pulse laser generation board, an intensity modulator control board, a phase modulator control board, a thermoelectric cooler control board, a synchronous laser generation board, and a variable optical attenuator control board so as to transmit photons.

10. The quantum communication control apparatus of claim 1, wherein, when the optical system is a Measurement-Device-Independent (MDI) quantum key distribution system, the at least one second control board comprises first to fourth single-photon avalanche diode driving and detection boards, first and second photodetector driving and detection boards, and first and second fiber polarization controller control boards so as to measure Bell states.

11. The quantum communication control apparatus of claim 1, wherein the quantum communication control apparatus is operated as a quantum communication test device for testing components of a quantum communication system.

12. A quantum communication system comprising:
a sender configured to transmit photons; and
a receiver configured to receive the photons through a quantum channel,
wherein each of the sender and the receiver comprises an optical system for quantum communication,
wherein each of the sender and the receiver comprises a quantum communication control apparatus, and
wherein the quantum communication control apparatus comprises:
a first control board configured to include a plurality of connectors and to reconstruct respective functions or signal standards of the plurality of connectors; and
a plurality of second control boards, each configured to include a connector to be connected to any one of the plurality of connectors and to control the optical system according to a protocol or a modulation scheme of quantum communication.

13. The quantum communication system of claim 12, wherein the optical system comprises a 1-way or 2-way quantum key distribution optical system to which a BB84 protocol is applied.

14. The quantum communication system of claim 12, wherein the optical system comprises a quantum key distribution optical system to which a B92 protocol is applied.

15. The quantum communication system of claim 12, wherein the optical system comprises a Measurement-Device-Independent (MDI) quantum key distribution optical system.

16. The quantum communication system of claim 12, wherein:
the quantum communication is configured to perform quantum cryptography communication via optical modulation, and
at least one of the plurality of second control boards is replaced according to an optical modulation scheme.

17. The quantum communication system of claim 12, further comprising a Bell state measurement unit configured to receive the photons output from a plurality of senders and measure relationships between quantum states of the received photons,
wherein the Bell state measurement unit comprises:
a main board configured to include connectors and to reconstruct respective functions or signal standards of the connectors; and
individual boards, each connected to any one of the connectors and configured to control the optical system according to the protocol or the modulation scheme.

18. A method for designing a quantum communication control apparatus, comprising:
preparing a main board having a plurality of connectors;
selecting individual boards according to a protocol or a modulation scheme of quantum communication; and
connecting each of the selected individual boards to a corresponding connector, among the plurality of connectors.

19. The method of claim 18, wherein:
each of the plurality of connectors is implemented in a form of a slot, and
connecting each of the selected individual boards to the corresponding connector comprises inserting the selected individual boards into corresponding slots in the main board.

20. The method of claim 18, wherein preparing the main board comprises reconstructing respective functions or signal standards of the plurality of connectors through programming of a Field-Programmable Gate Array (FPGA).
